(19) United States
(12) Patent Application Publication
(10) Pub. No.: US 2006/0163762 A1
(43) Pub. Date: Jul. 27, 2006

(54) Method and device for machining of an information-and/or structure carrier for injection molding forms

(75) Inventor: Markus Gabriel, Rombach (CH)

Correspondence Address: THE WEBB LAW FIRM, P.C., 700 KOPPERS BUILDING, 436 SEVENTH AVENUE, PITTSBURGH, PA, 15219, US

(73) Assignee: AWM MOLD TECH AG, Muri (CH)

(21) Appl. No.: 11/328,741

(22) Filed: Jan. 10, 2006

(30) Foreign Application Priority Data
Jan. 27, 2005 (CH) 0129/05

(51) Int. Cl. B29D 11/00

(52) U.S. Cl. 264/2.7; 425/542; 425/810

(57) ABSTRACT

A method and a device for the post-processing of a disc-shaped information- and/or structure carrier for injection molding forms is described, for example for a stamper for the production of CDs or DVDs, which has a central, substantially cylindrical opening. The information- and/or structure carrier is held in the injection molding form through a holding device penetrating the opening at least partially, for example a ring-shaped stamper holder. The information- and/or structure, respectively, is provided substantially concentrically to this opening on a surface facing the cavity of the injection molding form. In such a method the substantially cylindrical opening is provided with a chamfer on at least one side on the edge to one surface preferably on the surface carrying the information or structure, respectively, wherein during mounting into the injection molding form a self-centering of the stamper plate is effected, and a substantially allowance-free holding by the stamper holder, which on the resulting molded article (CD,DVD) does not give rise to ridges or grooves, and wherein the stamper plate is not provided with tensions due to its fastening.

### TECHNICAL FIELD

The present invention relates to the field of injection molding technique. It in particular relates to a method and a device for machining of a disc shaped information- and/or structure carrier (stamper) for injection molding forms, in particular for CD's or DVD's, which comprises a central, substantially cylindrical opening for fastening.

### BACKGROUND OF THE INVENTION

For the production of optically readable information carriers like Audio CD's, CD-ROM's, Video-CD's or DVD's, injection molding tools are used, which, by means of two opposite, in direction towards each other relatively movable mirror blocks form a cavity (cavity of the injection molding form). Usually, on one of the mirror blocks, a thin disc shaped stamper is removably fastened, which stamper during injection molding of the information carrier being formed embosses the information or at least structure comprising traces. This information and/or structure carrier is thus a 3D-template or embossing form or dye template, in which either the groove structure for embedding of the dye in case of writable media is provided as a negative, or in which the full information, which is optically read, in case of only readable media, is provided by means of additional structuring of the grooves as a negative. The negative data provided in the stamper are taken over by the formed article during the injection molding process in the plastic material.

The stamper is held in the injection molding tool by means of a so-called stamper holder. The stamper to this end comprises a central opening, in which the stamper holder at least partially intrudes. The stamper holder thus is a substantially ring shaped element, which, after the stamper has been put onto the mirror block, is introduced through its opening and is fixed on the mirror block, wherein the fastening is provided by means of interaction of the outer diameter of the stamper holder with the inner diameter of the opening of the stamper. This fastening may either be provided by form closure by means of holding noses or ribs on the stamper holder, or by force closure by means of vacuum directly on the mirror block, wherein in the latter case the stamper holder substantially provides the centring function.

Due to the increasingly high read- and write speeds, which have to be achieved with data carriers produced this way, also the requirements in respect to eccentricity (ECC) are increasing. The eccentricity is defined as the difference between the two axes of the central hole of the data carrier and the information grooves of the data carrier. In specifications, typically the following measures have to be kept
CD-A ECC<70 μm
DVD-R ECC<20 μm.

The total eccentricity is given by the sum of the deviations of stamper, tolerances of the device as well as widenings of the central opening of the stamper (among others wear due to lateral forces during use or during mounting).

The accuracy of the inner diameter of the central opening of the stamper, which typically is made of nickel or a nickel alloy in a photochemical process, is thus decisive for eccentricity. The central opening of the stamper is made by punching. During punching of this opening, different punching regions are generated due to technical reasons of the material. At the entrance edge of the punching tool, a radius or a slight flattening or truncation is generated, and at the exit edge a small ridge or even chipped spots. In between there is a substantially cylindrical region.

In particular the size and the direction of the radius/truncation which is formed in the entrance region can only be controlled with much difficulty and it varies in dependence of the punching stamp, the hardness of the stamper, the temperature and the speed during punching, on protective lacquers, etc. All these effects are detrimental to a precise centring of the central diameter of the central opening of the stamper.

Correspondingly there is a need to be able to, without too much effort, provide a very precise inner diameter of the stamper and to keep the eccentricity on a minimum.

### DETAILED DESCRIPTION OF THE INVENTION

It is thus one object of the invention to provide a process as well as a device for the more precise formation of a central opening of an information and/or structure carrier for injection molding tools, in order to keep the eccentricity of a data carrier (CD, DVD) produced using such information and/or structure carrier on a minimum.

In particular a method for machining of a disc-shaped information- and/or structure carrier for injection molding tools shall be provided, which information- and/or structure carrier comprises a central, substantially cylindrical opening, wherein the information and/or structure carrier is of the type which is fastened within the injection molding form by means of a holding device with at least partially penetrates the opening, and in which the information and structure, respectively is provided substantially concentrically to this opening on a surface facing the cavity of the injection molding form.

One solution to this object is achieved in that the substantially cylindrical opening is provided with a chamfer on at least one side at the edge towards a surface. In other words, an already existing central opening of the information- and/or structure carrier normally produced in a punching process is post-processed in that one of the edges between the surface and the cylindrical circumferential surface of the central opening is made conical.

One of the essential elements of the invention thus resides in the fact, primarily not to improve the punching process, but to get rid of the problems generated during punching in a post-processing step. To this end a post-processing is used, which allows holding through the central opening, effecting a self-centring of the information- and/or structure carrier during fastening in the injection molding form, and which correspondingly improves the value of the eccentricity. Surprisingly it is thus very simply possible to get rid of the uncontrollable variabilities generating during the punching process by means of a simple and reliable step of post-processing.

According to a first preferred embodiment the edge is provided with a chamfer by means of removal of material either circumferentially or in sections. The removal of material prevents that substantial modifications in the material structure take place, which may lead to tensions and correspondingly to additional eccentricities or wear and tear.

The chamfer or conical taper may be provided on the edge between the cylindrical opening and the surface facing away from the cavity of the injection molding form of the information- and/or structure carrier. In this case the self-centring effect for example takes place if the information and/or structure carrier is held on the mirror block by means of a vacuum fastening. A fastening effect on the mirror block is however not achieved unless additional means are provided.

Preferentially however, the chamfer is alternatively or in addition to that provided on the edge between the cylindrical opening and the surface carrying the information or structure, respectively. Like this a correspondingly structured stamper holder, can, without giving rise to tensions or material dislocations, be introduced into this conical taper and can on the one hand fasten the information- and/or structure carrier on the mirror block and on the other hand it can also optimally centre it.

According to a further preferred embodiment the information- and/or structure carrier is a stamper for the production of an optical data carrier, in particular of a CD or DVD, and the injection molding form is an injection molding tool for the making of disc-shaped information carriers, in particular in the form of CD's and or DVD's. The injection molding tool for the formation of a cavity comprises a first and a second mirror block, which are located opposite to each other, and which for opening and closure of the form are movable relative to each other, comprising preferentially additionally a form ring, which concentrically encloses the first mirror block and which borders the cavity to its outer edge and which is movable relative to the first mirror block.

Preferentially the stamper has a thickness (h) in the range of 0.2-0.5 mm, preferentially in the range of 0.25-0.35 mm. Normally the stamper is made of pure nickel or a nickel alloy.

According to a further preferred embodiment the chamfer is machined circumferentially (by means of removal of material) and the conical taper or chamfer with the normal to the stamper encloses an angle of 5-60°, preferentially of 7-20°, and particularly preferably of 10-15°. The depth of the chamfer for example is in the range of 0.1-0.3 mm, preferentially in the range of 0.15-0.25 mm. The ratio of the depth of the chamfer to the thickness of the stamper for example is in the range of 0.1-0.9, preferentially of 0.25-0.5, and particularly preferably of 0.6-0.7. The extension of the chamfer in radial direction (width) preferably is 0.03-0.1 mm, particularly 0.05-0.08 mm.

According to a further preferred embodiment of the method according to the invention, the production of the chamfer takes place by means of a cutting head with several, substantially conically oriented cutting edges, in particular in the form of a countersink, or with a conical grinding surface, which is guided into the opening of the structure- and/or information carrier in a concentrical and controlled manner until reaching a defined limit-stop, and in that the chamfer is produced by means of removal of material, wherein particularly preferably the removal of material takes place manually, i.e. the rotation of the cutting head is provided manually. It is however also possible to provide this by using a motor.

The method can be carried out in a particularly simple manner if a device as follows is used: a device for the machining of a disc-shaped information- and/or structure carrier for the injection molding forms, comprising first means for the controlled fastening of the information and/or structure carrier, and comprising a grinding- and/or cutting tool which by second means can be introduced into the central opening of the fastened information- and/or structure carrier in a concentrical manner. Thereby, by means of a rotation of the grinding- and/or cutting tool, the substantially cylindrical opening is provided with a chamfer on at least one side at the edge to a surface, i.e. the edge is preferably provided with a circumferential chamfer.

A first preferred embodiment of the device is characterised in that the first means are given as a cutting plate, in which holding means for the information- and/or structure carrier are provided, wherein preferentially these holding means are given by magnets and/or positioning ribs (for example at least partially circumferential around the outer edge of the stamper), and/or vacuum aspiration devices.

A further preferred embodiment of the device according to the invention is characterised in that the second means are given as a guiding column attached to the first means either tightly or rotatably, which penetrates through the central opening in a concentrical manner and perpendicular to the surface of the information- and/or structure carrier, and wherein the grinding- and/or cutting tool is provided with a corresponding, substantially cylindrical opening or bore in the tip, in which the guiding column, if need be with interposing friction reducing bearings, preferably in the form of a ball cage, is introduced such that the grinding- and/or cutting tool is rotatable concentrically to the central opening.

Alternatively, so to speak in a kinematic exchange, it is possible to provide a device, which is characterised in that the second means are provided as a guide column penetrating through the central opening in a concentrical manner, which is fastened to the grinding- and/or cutting tool tightly or rotatably and coaxially, and in that the first means are provided with a corresponding substantially cylindrical opening or bore perpendicular to the surface of the information- and/or structure carrier, if need be with interposition of friction reducing bearings, preferably in the form of a ball cage, in which the guide column is introduced such that the grinding- and/or cutting tool is rotatable concentrically to the central opening.

Preferably the cutting tool is a countersink and/or a deburring sink, which particularly preferably comprises at least three, preferably four to eight cutting edges. Further more the grinding- and/or cutting tool is preferably designed such as to be manually actuated for removal of material.

Further preferred embodiments are described in the appended claims.

### SHORT DESCRIPTION OF THE FIGURES

The invention shall be illustrated in the following by means of the examples in conjunction with the drawings. The examples merely serve to illustrate the invention and shall not be constructed for limiting the scope of the invention as defined in the dependent claims. The figures show:

FIG. 1 in a schematical and simplified longitudinal cut an injection molding tool according to the state of the art;

FIG. 2 a)-c) different cut outs according to circle A as given in FIG. 1 for different possibilities of the fastening of the stamper in the injection molding form;

FIG. 3 again a cut out according to circle A in FIG. 1 for the fastening using a conical stamper holder with a stamper with a conical taper;

FIG. 4 again a cut out according to circle A in FIG. 1 for the fastening using a conical stamper holder with holding nose with a stamper with chamfer;

FIG. 5 different views of a device for post-processing of a stamper, a) perspective view, b) explosion view, c) cut according to A-A in d), top view onto the cutting plate, e) cut according to B-B in d).

### DETAILED DESCRIPTION OF THE PREFERED EMBODIMENT

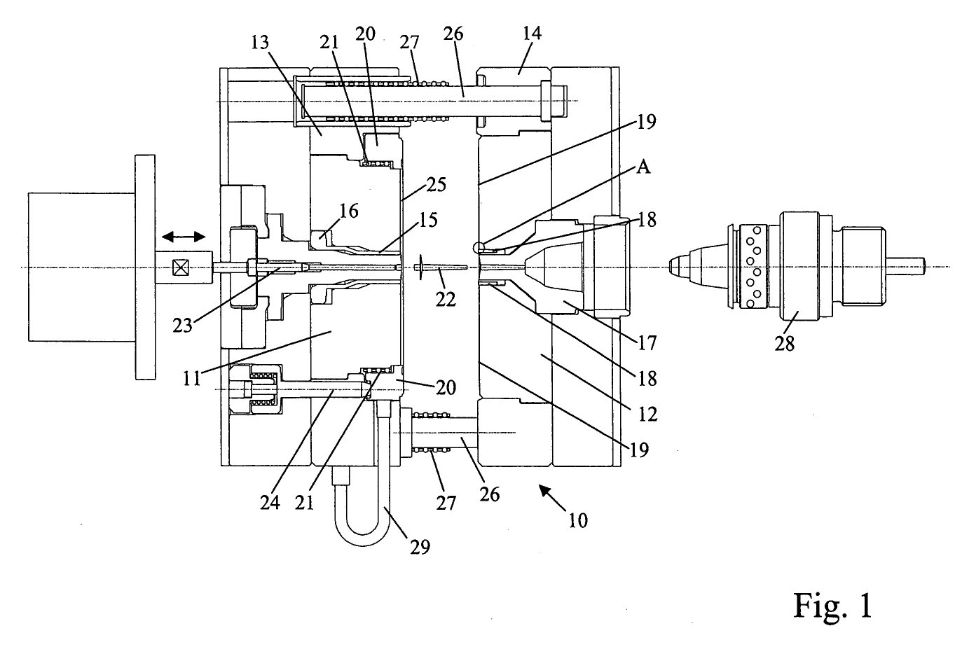

In FIG. 1 an injection molding tool according to the state of the art is shown in a longitudinal cut, as it is for example disclosed in EP-A1-1 120 221, in a schematical manner. The figure is thereby simplified in so far as there is no display of the necessary screws, springs, sealing elements or manipulation elements etc.

The injection molding tool 10 which is shown in open state comprises as central parts a first (left) mirror block 11, a second (right) mirror block 12, and a form ring (venting ring) 20, enclosing the first mirror block 11 concentrically, which together, if the form is closed, form the cavity 25. Each of the mirror blocks 11, 12 is mounted in a concentrically enclosing centring ring 13, 14, respectively. The information is embossed or formed during the injection into the molded form (the CD/DVD) by means of a stamper 19, which is provided as a thin disc on the surface of the form of the second mirror block 12 and adjacent to it, and which is held in the centre by means of a bush-type stamper holder 18. For the connection of the injection molding tool 10 to the nozzle 28 of the injection molding machine a sprue bush 17 is provided penetrating to the centre of the second mirror block 12 to the sprue bush 17 extending to the cavity 25, which sprue bush opens conically towards the outer side.

Opposite to the sprue bush 17 there is provided concentrically and located within each other and relatively movable (indicated by means of the double arrows) an injector sleeve 16, a punch 15 and a sprue ejector 23. With the sprue ejector 23 the sprue 22 (for illustration displayed in the centre of the open form) remaining in the inner bore of the sprue bush 17 can be ejected. With the punch 15, the central opening is punched in the injection molded CD or DVD, respectively. With the ejector sleeve 16 the finished CD can finally be ejected after opening of the cavity 25.

The form ring 20 is mounted movably in the centering ring 13, and is pressed towards the second mirror block 12 by means of springs. By means of a pneumatically driven operating element 24 it can be discharged. The form ring 20 does not directly abut with the inner side to the outer side of the first mirror block 11, but it is separated therefrom by means of a ball cage 21, which is concentrically provided on a set-off provided on the outer side of the first mirror block 11. The ball cage 21 substantially has the form of a hollow cylinder. It thus acts as a sliding bearing for the form ring 20 made of steel and the first mirror block 11 also made of steel.

The two halves of the injection molding form 10 are mounted movable relative to each other by means of guiding columns 26 (normally four such columns), wherein for easy relative mobility these guiding columns 26 are bearing mounted by means of ball cages 27 in corresponding recesses. The mirror blocks 11 and 12, respectively, as well as if need be also the venting ring 20 comprise means for tempering or may also be provided with vacuum, and this is schematically indicated for the venting ring 20 by the inlet for media 29.

In connection with such an injection molding tool 10, by means of the circular cut out A, as given in FIG. 1, the invention shall be illustrated in more detail. The circle A in FIG. 1 specifies the region, in which the stamper holder 18 penetrates into the central opening of the stamper plate, and fixes the stamper 19 in the injection molding form or at least centres it.

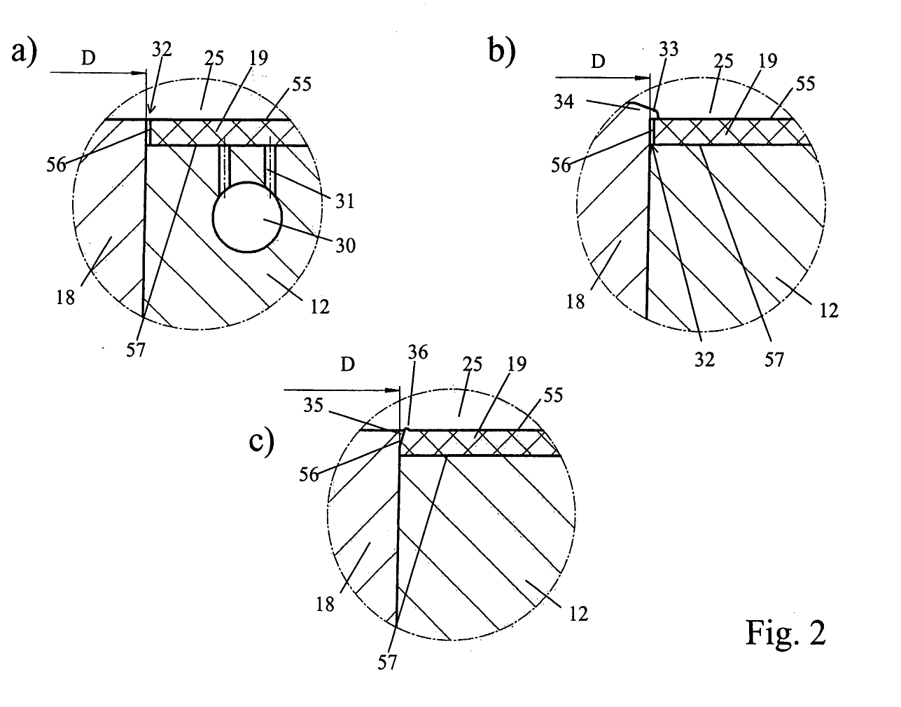

The FIGS. 2-4 show the cut out A as given in FIG. 1 in detail for different embodiments of a stamper holder 18 and/or mirror block 12 and/or stamper 19.

In FIG. 2 different possibilities for fastening of the stamper plate 19 are given, wherein in each case a stamper 19 is used which has not specifically been post-processed, i.e. which comprises a central opening 56 which has been produced in a simple punching process. The central opening 56 is thus substantially cylindrical, apart from the above mentioned deformations which are produced during the punching process in the edge regions.

FIG. 2a) shows the possibility, to substantially only centre the stamper 19 by the stamper holder 18 and to actually effect the fixation on the mirror block 12 by means of a vacuum aspiration. To this end the mirror block 12 is provided with at least one vacuum channel 30, which is open towards the surface of the mirror block 12 via the aspiration openings 31. The stamper 19 with its lower surface 57, which is not provided with a 3-dimensional structure or information, rests on the surface of the mirror block 12, and is held on the mirror block if a vacuum is provided in the channel 30.

The outer diameter D of the stamper holder 18 is for example 22 mm, wherein a tolerance in the range of +0.0 mm and −0.005 mm/−0.01 mm, respectively, is admitted. The inner diameter of the central opening 56 of the stamper is also designed to be 22 mm, wherein however, for reasons of safety (the diameter of the central opening may under no circumstances be smaller than the outer diameter of the stamper holder 18 within the limits of the tolerances) here the tolerances are designed to be in a region of +0.01 mm and −0.0 mm. Thereby an allowance 32 in the region of the central opening 56 is produced which is in the range of 0.005-0.020 mm, and which finally does not allow a qualitatively high valued eccentricity.

Even if the stamper is provided with an accurate central opening 56 due to this allowance 32 the whole stamper and correspondingly also the information which is provided concentrical to the central opening 56 on the surface 55 of the stamper can be shifted within the limits of this tolerance, contributing thus to the eccentricity of the finally produced data carrier. The problem of this solution is also that in the mirror block 12 vacuum channels 30 have to be provided for fastening of the stamper. Since however in the mirror block 12 for tempering there is also necessity for channels for the tempering medium, difficult conditions are given in the mirror block 12 due to the requirement of the channels 30.

An alternative is given in FIG. 2b). In this case the stamper holder is provided with a holding nose 33, which grips the stamper 19, which in principle is structured as the stamper which is already described in connection with FIG. 2a), from the upper side. Correspondingly the stamper 19 is fixed onto the mirror block 12 by this holding nose 33, and a vacuum fixation as given in FIG. 2a) is not necessary anymore, it may however be provided in support. A fixation using such a typically circumferential holding nose 33 however has the following disadvantages: First a slight elevation 34 has to be accepted in the region of this holding nose 33. In conjunction with the production of data carriers, in which two halves are glued to each other (for example DVD) the circumferential recess produced in the molded article due to this elevation 44 can be used for taking up glue (so called bonding groove), in all other cases it is however not truly useful and it is a disadvantage if the data carrier shall be printed on the full surface. Furthermore also here there is the problem of the allowance 32. It may however be reduced by means of the fastening 33 partially, that, if the stamper 19 is once mounted, a motion within the limits of this allowance 32 takes place, however the eccentricity generated during mounting of the stamper 19 is also maintained in this possibility of fastening. Furthermore the holding nose 33 is a very delicate element (the holding nose 33 usually only protrudes by approximately 0.2-0.3 mm), which on the one hand has to be produced very precisely, and which on the other hand may easily break off.

A further possibility is given in FIG. 2c). In this case the stamper holder 18 is used, which on its upper outer edge is designed slightly conically expanding. The corresponding chamfer 35 is forced into the central opening of a stamper 19 with cylindrical central opening 56, if the stamper is fastened in the injection molding form. During this step a deformation of the stamper 19 in the region of the central opening 56 takes place, and since the pressed material has no other way to go, a ridge 36 of material is generated penetrating into the cavity 25. This possibility of fastening reduces eccentricity, which is there due to the allowance 32, to a certain extent, it on the other hand however leads to hardly controllable grooves, notches or burrs which haptically are undesired, and which may disturb during gluing or printing. Furthermore due to the forced fastening tensions and deformations are generated in the stamper, which again contributes to eccentricity and reduces the quality of the produced data carrier.

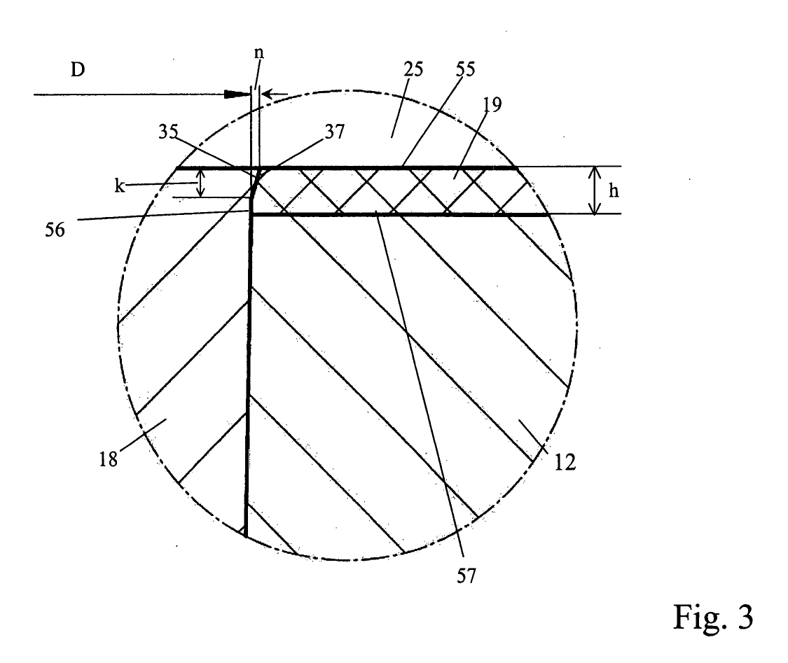

FIG. 3 now shows how a stamper, which has been post-processed in accordance with the invention can be fastened to the mirror block 12, using substantially a stamper holder 18 as it is shown in FIG. 2c). In this case the stamper 19 is provided with a conical taper or chamfer 37 prior to mounting it in the injection molding tool, i.e. using a tool as it is described further below, i.e. by means of removal of material. The chamfer 37 of the stamper 19 is substantially adapted to the chamfer 35 of the stamper holder 18.

In other words the chamfer 37, e.g. at a height h of the stamper of 0.3 mm is provided over a depth k of 0.2 mm, wherein this chamfer 37 has a width n in radial direction of 0.06 mm. Due to the preceding machining of the upper edge, i.e. the edge between the inner circumferential surface of the central opening 56 of the stamper and the information carrying surface 55 of the stamper 19, there is no generation of tensions during mounting, and the final eccentricity can thus be improved. In addition to that due to the reciprocal conical shape of the stamper holder 18 and the stamper 19 a reciprocal centering effect during mounting is provided leading to an optimal eccentricity furthermore.

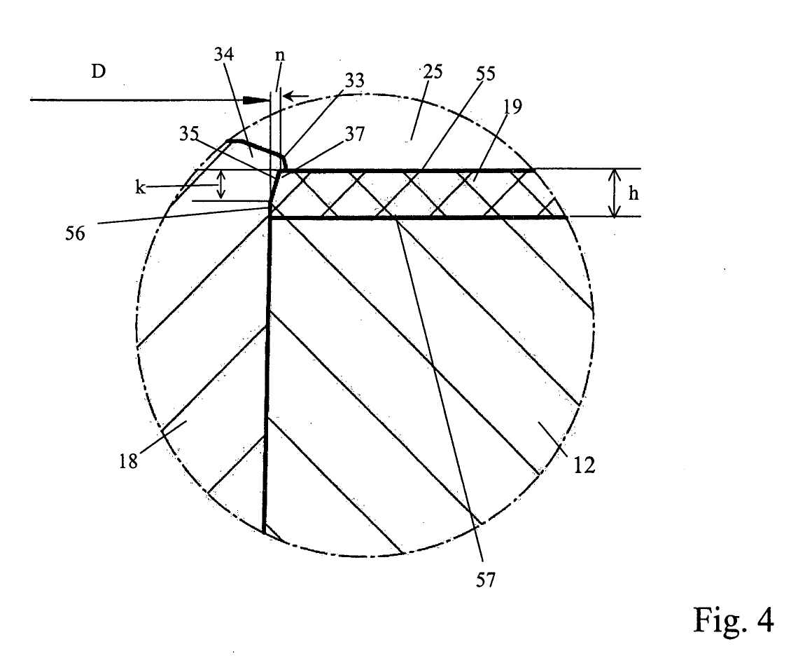

In FIG. 4 an analogous design is shown for the case of an additional holding nose 33. In this case a pre-machined stamper 19, as it is described in the context of FIG. 3, is used. The stamper holder in this case is provided with a chamfer 35 and at the same time also with a holding nose 33. The holding nose protrudes again further over the stamper 19 and fixes it further on the mirror plate 12. The projection of the holding nose 33 over the stamper 19 is again approximately 0.06 mm, which leads to a total projection of the holding nose of approximately 0.15 mm, and an outer diameter of the holding nose of approximately 22.3 mm, respectively. The combination of a holding nose 33 with a conical tapering 35 on the one hand has the advantage as already described in the context of FIG. 3, on the other hand it furthermore has the advantage that the holding nose 33 in comparison with a stamper holder as given in FIG. 2b) is much better supported on the lower side and can thus mechanically more heavily be loaded.

In the context with the chamfer 37 described in conjunction with the FIGS. 3 and 4 of the stamper can be produced using different manners. It is for example possible to provide the punching tool, which is used during the punching of the central opening 56 on the stamper 19, with a corresponding tapering. In this case however again there is material dislocations which are similar to those which have already been described in conjunction with FIG. 2c), and which correspondingly can show detrimental effects. It is also possible to produce the chamfer 37 after the punching in a subsequent forming process. Since however such a forming process again is chipless, and correspondingly again material is dislocated, similar problems arise.

Preferably therefore a post-processing is used in which material is removed in a gentle manner. This is typically in a chipping manner, and either using a grinding tool or a cutting tool, wherein the latter for example may be a countersink, which can only be introduced into the central opening of the stamper until reaching a limit stop.

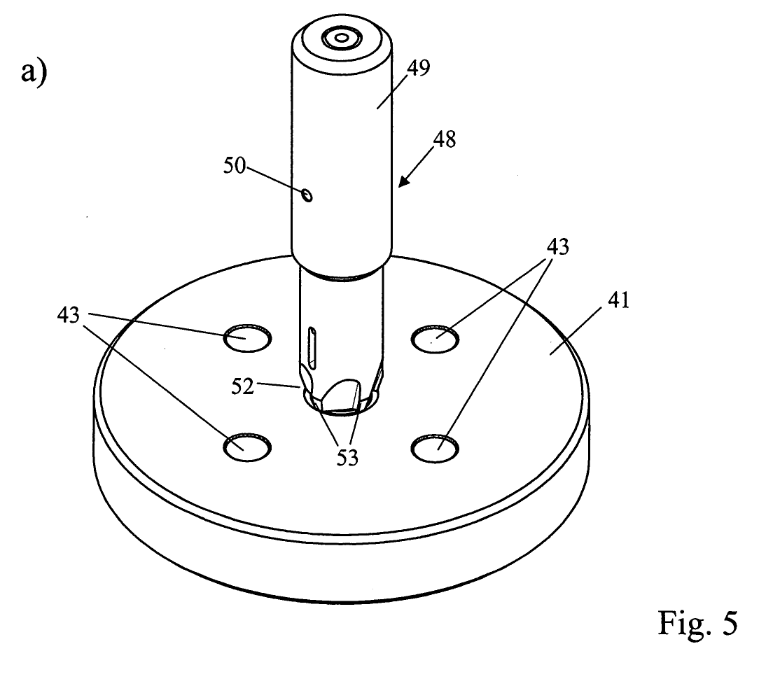

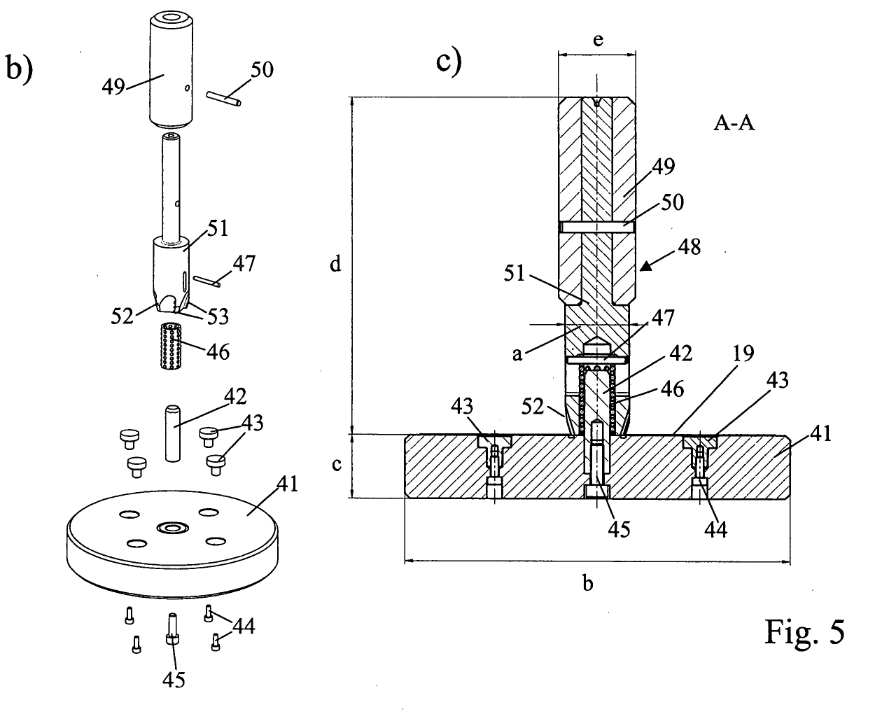

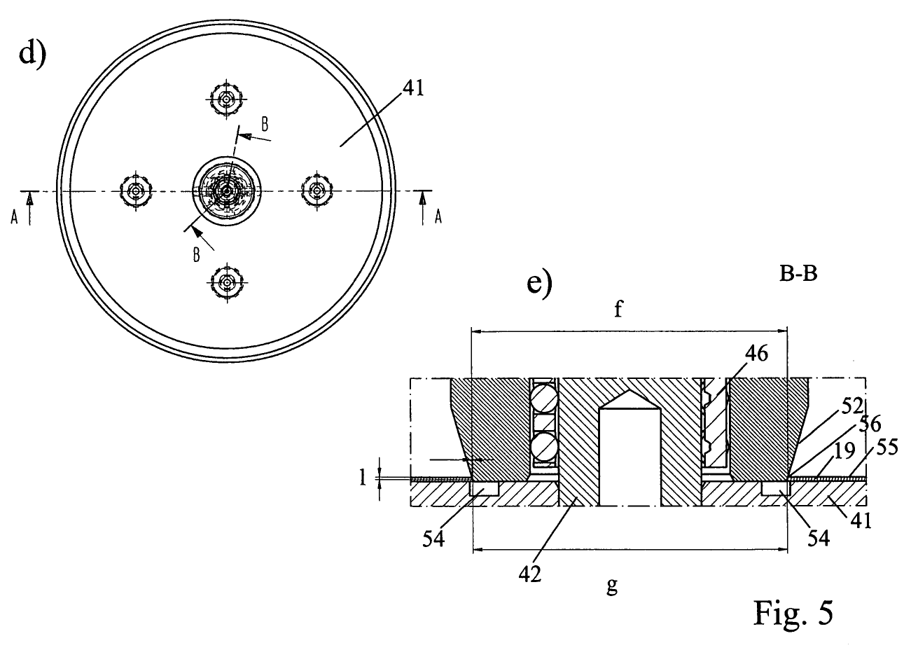

A particularly useful tool for the post-processing of the stamper according to the invention is given in FIG. 5 in detail. FIG. 5a) shows a perspective view, FIG. 5b) an explosion view, FIG. 5c) a cut according to A-A in FIG. 5d), FIG. 5d) a top view onto the cutting plate 41 and FIG. 5e) a cut according to B-B in FIG. 5d). In FIG. 5 equal parts are designated with equal reference numerals in the different displays.

A device according to FIG. 5 is made to manually post-process a stamper 19, which has already been provided with a punched central opening 56. To this end a cutting plate 41 is provided, which substantially has the size of the stamper 19. In order to fasten the stamper 19 on this cutting plate 41, magnets 43 are embedded in this cutting plate 41, wherein the magnets 43 are fastened in penetrating bores by means of screws 44. The magnets 43 allow a fastening permitting a slight mobility. It is possible to in addition to that provide at least partially circumferential grooves or notches or the like on the cutting plate 41 in order to allow a positioning of the stamper 19.

At least partially in a central bore of the cutting plate in addition to that there is provided a guide column 42 and it is fastened by means of a screw 45 from the bottom. The guide column 42 is perpendicular to the cutting plate 41.

The stamper 19 is put onto the cutting plate 41 in that its central opening 56 is imposed on the guide column 42. Subsequently the cutting tool 48, which on its tip is provided with central or which is adapted to the guide column 42, is put onto the guide column 42 and moved downwards. The cutting tool 48 is mounted around the guide column 42 rotatably by means of a ball cage 46. It comprises a central cutting core 51, about which on its upper end a handle 49 is provided and is fastened with a pin 50. On its lower end the central cutting core 51 is provided with the already mentioned central bore for taking up the guide column 42, and the ball cage 46 is mounted in this central bore by means of a pin 47. On the tip the cutting head 52 is given, in that several cutting edges 53, specifically in this case there is six of them (there is also more than that or less than that possible) are provided. The cutting head 52 is similar to a cutting head, as it is used in the context of countersinks.

The desired chamfer 37 can now manually be produced on the stamper 19 in a highly controlled manner, if the cutting tool 48 is introduced into the central opening 56 under rotation and concomitant removal of material. By means of the guide column 42 an optimal centring and guidance is provided, and at the same time due to the design of the tip 52 and the limit stop on the cutting plate 41 it is made sure that the chamfer 37 has the desired depth k.

In Detail for example the following dimensions were chosen: diameter of the cutting plate 41: b=150 mm; diameter of the cutting core 51: a=25 mm; height of the cutting plate 41: c=25 mm; height of the mounted cutting tool 48: d=130 mm; diameter of the handle 49: e=30 mm. The control measure of the cutting head 52 on the height 0.3 mm is: f=22.09 mm; the diameter at the tip of the cutting head 52 is: g=21.99 mm; the depth of the chamfer is: 1=ca. 0.2 mm.

In summary the following advantages are provided due to the post-processing of the stamper 19 and the use of the described tool, respectively:
reduced eccentricity of the stamper to the central axis of the tool
less shifted material on the conical part
less tensions on the stamper
improved printing of the substrate in the transition region between stamper holder and stamper
improved flow of the plastic material in the transition region from stamper holder to stamper
self centring effect during mounting and use
improvement of the process for bonding of the DVD half sides.

### LIST OF REFERENCE NUMERALS

10 injection molding tool
11, 12 mirror block
13, 14 centring ring
15 punch
16 ejector sleeve
17 sprue bush
18 stamper holder
19 stamper
20 form ring or venting ring
21 sliding bearing, ball cage bearing
22 sprue
23 sprue ejector
24 operating element
25 cavity
26 guide columns
27 ball cage
28 coupling element for injection molding material
29 inlet for media
30 vacuum chanel in 12
31 suction intake
32 slot
33 holding nose
34 elevation
35 chamfer on 18
36 ridge of material on 19
37 chamfer, conical tapering on 19
41 cutting plate
42 guide column
43 flat magnet
44 screw
45 screw
46 ball cage
47 cylinder pin
48 cutting tool
49 handle
50 cylinder pin
51 cutting core
52 cutting head
53 cutting edge
54 circumferential channel
55 surface of 19 with structure, information, respectively
56 opening in 19
57 surface of 19 without structure, information, respectively
a lower diameter of 51
b diameter of 41
c thickness of 41
d height of 41
D outer diameter of the stamper holder
e upper diameter of 48
f control measure on the height of 0.3 mm
g diameter at the tip of 52
h thickness of 19
i difference of the radii of f and g
k depth of 35
l minimal height in the tolerance region
n width of the chamfer 37

1-16. (canceled)

17. A method for machining of a disc-shaped information and/or structure carrier for injection molding forms, comprising a central, substantially cylindrical opening, wherein the information and/or structure carrier is held in the injection molding form through a holding device penetrating at least partially through the opening, and in which the information or structure, respectively, is provided substantially concentrically to this opening on a surface facing the cavity of the injection molding form, wherein, the substantially cylindrical opening is provided with a chamfer on at least one side on the edge to one of the surfaces.

18. The method according to claim 17, wherein the chamfer is produced by removal of material either circumferentially or in sections.

19. The method according to claim 18, wherein a chamfer is generated at the edge between the cylindrical opening and the surface carrying the information or structure, respectively.

20. The method according to claim 19, wherein the information and/or structure carrier is a stamper for the manufacturing of an optical data carrier and wherein the injection molding form is an injection molding tool for the manufacturing of disc-shaped information carriers, which injection molding tool for the formation of a cavity comprises a first and a second mirror block which are located opposite to each other and for opening and closure of the form are movable relative to each other, as well as a form ring which concentrically encloses the first mirror block and which limits the cavity towards its outer edge and which is movable relative to the first mirror block.

21. The method according to claim 20, wherein the stamper has a thickness (h) in the range of 0.2-0.5 mm.

22. The method according to claim 21, wherein the chamfer is provided circumferentially and encloses an angle to the normal of the stamper of 5-60°.

23. The method according to claim 21, wherein the depth (k) of the chamfer is in the range of 0.1-0.3 mm.

24. The method according to claim 17, wherein prior to the generation of the chamfer the opening is generated in a punching process.

25. The method according to claim 17, wherein the chamfer is generated in that a cutting head with several, substantially conically arranged cutting edges is introduced into the opening of the structure- and/or information carrier in a concentrical and controlled manner until reaching a defined limit stop, and wherein the chamfer is generated by removal of material.

26. A device for the processing of a disc-shaped information- and/or structure carrier for injection molding forms which information- and/or structure carrier comprises a central, substantially cylindrical opening, wherein the information- and/or structure carrier is intended to be mounted in the injection molding form and held through a holding device at least partially penetrating the opening, and on which information- and/or structure carrier the information or structure, respectively, is provided substantially concentrically to this opening of the surface facing the cavity of the injection molding form, wherein, first means are provided for the controlled fastening of the information- and/or structure carrier, and wherein a grinding- or cutting tool is provided, which by second means can be introduced into the central opening of the fastened information- and/or structure carrier in a concentrical manner, and wherein by rotation of the grinding- and/or cutting tool the substantially cylindrical opening can be provided with a chamfer on at least one side of the edge to one surface.

27. The device according to claim 26, wherein the first means are a cutting plate in which holding means for the information- and/or structure carrier are provided, wherein preferentially these holding means are given as magnets and/or positioning ribs and/or vacuum aspiration devices.

28. The device according to claim 26, wherein the second means are provided as a guide column fastened either tightly or rotatably to the first means penetrating through the central opening concentrically and oriented perpendicularly to the surface of the information- and/or structure carrier, and wherein the grinding- and/or cutting tool is provided with a corresponding, substantially cylindrical opening or bore in its tip, in which the guide column if need be with interposition of friction reducing bearings is introduced such that grinding- and/or cutting tool is rotatable concentrically to the central opening.

29. The device according to claim 26, wherein the second means are given as a guide column which is connected either tightly or rotatably with the grinding- and/or cutting tool in a coaxial manner penetrating the central opening concentrically, and wherein the first means is provided with a central opening or bore which is substantially cylindrical and perpendicular to the surface of the information- and/or structure carrier, in which the guide column if need be with interposition of friction reducing bearings is introduced such that the grinding- and/or cutting tool is rotatable concentrically to the central opening.

30. The device according to claim 26, wherein the cutting tool is a countersink or deburring sink, comprising at least three cutting edges.

31. The device according to claim 26, wherein the grinding- and/or cutting tool is designed for manual manipulation for the removal of material from the stamper.

32. The method according to claim 20, wherein the optical data carrier is one from the group consisting of a CD and a DVD.

33. The method according to claim 21, wherein the stamper thickness is in the range of 0.25-0.35 mm.

34. The method according to claim 21, wherein the stamper is made from one of the group consisting of nickel and a nickel alloy.

35. The method according to claim 22, wherein the chamfer encloses an angle between 7-20°.

36. The method according to claim 35, wherein the chamfer encloses an angle between 10-15°.

37. The method according to claim 23, wherein the depth (k) of the chamfer is in the range of 0.15-0.25 mm.

38. The method according to claim 23, wherein the ratio of the depth (k) of the chamfer to the thickness (h) of the stamper is in the range of 0.1-0.9.

39. The method according to claim 23, wherein the ratio of the depth (k) of the chamfer to the thickness (h) of the stamper is in the range of 0.25-0.50.

40. The method according to claim 23, wherein the ratio of the depth (k) of the chamfer to the thickness (h) of the stamper is in the range of 0.6-0.7.

41. The method according to claim 25, wherein the cutting edges are in the form of one from the group of a countersink or a conical grinding surface.

42. The method according to claim 25, wherein the removal of material is introduced manually.

43. The device according to claim 39, wherein the bearings are in the form of a ball cage.

44. The device according to claim 30, wherein the cutting tool comprises between three to eight cutting edges.
